(19) United States
(12) Patent Application Publication
(10) Pub. No.: US 2017/0132278 A1
(43) Pub. Date: May 11, 2017

(54) Systems and Methods for Inferring Landmark Delimiters for Log Analysis

(71) Applicant: NEC Laboratories America, Inc., Princeton, NJ (US)

(72) Inventors: Junghwan Rhee, Princeton, NJ (US); Jianwu Xu, Lawrenceville, NJ (US); Hui Zhang, Princeton Junction, NJ (US); Guofei Jiang, Princeton, NJ (US)

(21) Appl. No.: 15/340,341

(22) Filed: Nov. 1, 2016

Related U.S. Application Data
(60) Provisional application No. 62/252,683, filed on Nov. 9, 2015.

(51) Int. Cl. G06F 17/30

(52) U.S. Cl. CPC G06F 17/30395; G06F 17/30477

(57) ABSTRACT

Systems and methods are disclosed for analyzing logs generated by a machine by analyzing a log and identifying one or more abstract landmark delimiters (ALDs) representing delimiters for log tokenization; from the log and ALDs, tokenizing the log and generating an increasingly tokenized format by separating the patterns with the ALD to form an intermediate tokenized log; iteratively repeating the tokenizing of the logs until a last intermediate tokenized log is processed as a final tokenized log; and applying the tokenized logs in applications.

### BACKGROUND

The present invention relates to machine logging of data and analysis thereof.

Many systems and programs use logs to record errors, internal states for debugging, or their operations. To understand the log information, it is an essential step to break the input log data into a series of smaller data chunks (i.e., tokens) using separators (i.e., delimiters). This process is called tokenization. However, this log format is not standardized and, programs use their own customized format and delimiters. Therefore, it becomes a significant challenge for log analysis to determine possible formats and delimiters especially when the program code is not available therefore no domain knowledge available regarding the logs.

For tokenization of log information, the choice of delimiter is important. Some logs, for instance, written in the CSV format follow a well-established format standard using a comma as a delimiter. However, logs without following such a format will use custom delimiters which are not easy to determine. Blindly selecting delimiters may cause confusion in the tokenized log. For instance, some passwords or hash values may include special characters which mean non-numeric and non-alphabet characters such as a comma, $, *, # etc. In an example of a string, a$j,s&*,sf2, a comma is not used as a delimiter. Instead, it is just one of special characters similar to $, &, and *. However, using a comma as a delimiter will tokenize this example string into three tokens (e.g., a$j s&* sf2) causing confusion. This inaccurate determination of tokens can affect the quality of applications using logs such as anomaly detection, fault diagnosis, and performance.

Prior approaches such as Logstash and Splunk in log analysis primarily apply a manual approach that specifies the log format including delimiters. In such an approach, a human needs to define the parsing rules for a given log format. For an unknown format, the parsing rule cannot be accurately determined.

### SUMMARY

In one aspect, systems and methods are disclosed for analyzing logs generated by a machine by analyzing a log and identifying one or more abstract landmark delimiters (ALDs) representing delimiters for log tokenization; from the log and ALDs, tokenizing the log and generating an increasingly tokenized format by separating the patterns with the ALD to form an intermediate tokenized log; iteratively repeating the tokenizing of the logs until a last intermediate tokenized log is processed as a final tokenized log; and applying the tokenized logs in applications.

In another aspect, a system for handling a log includes a module for processing the log with code for: analyzing the log and identifying one or more abstract landmark delimiters (ALDs) representing delimiters for log tokenization; from the log and ALDs, tokenizing the log and generating an increasingly tokenized format by separating the patterns with the ALD to form an intermediate tokenized log; iteratively repeating the tokenizing of the logs until a last intermediate tokenized log is processed as a final tokenized log; and applying the tokenized logs in applications.

In another aspect, an automated method is disclosed to infer the patterns to be used as reliable delimiters based on their consistent and reliable appearance in the whole log file. These delimiters are determined in three different types of patterns and are called Abstract Landmark Delimiters (ALDs). The term “Landmark” refers to the characteristic of the delimiters appearing consistently throughout the log. Further, we present our method to use ALDs for increasingly tokenizing a log into a more tokenized format selectively and conservatively step by step in multiple iterations. This method stops when no more further change is possible in tokenization.

Advantages of the system may include one or more of the following. The method enables tokenization of logs with higher quality by selecting reliable delimiters. Thus it will improve the understanding of logs and provide high quality solutions based on log analysis such as anomaly detection, fault diagnosis, and performance diagnosis of software.

### BRIEF DESCRIPTION OF THE DRAWINGS

FIG. 1 shows an exemplary architecture of a Landmark Log Processing System

FIG. 2 shows an exemplary Landmark Analysis module

FIG. 3 shows an exemplary Special character pattern analysis module.

FIG. 4 shows an exemplary Word pattern analysis module.

FIG. 5 shows an exemplary Constant pattern analysis module.

FIG. 6 shows an exemplary Incremental Tokenization module.

FIG. 7 shows exemplary hardware with actuators/sensors such as an Internet of Things system.

### DESCRIPTION

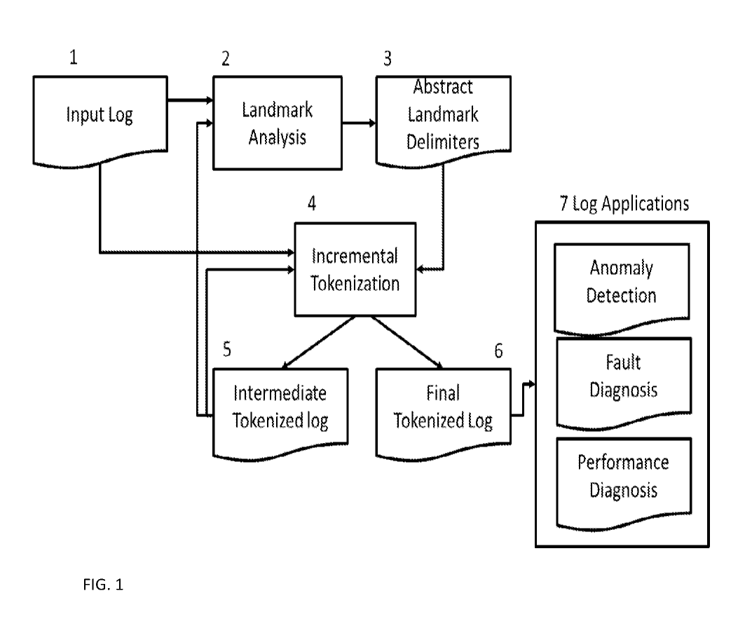

FIG. 1 presents the architecture of an exemplary Landmark Log Processing System. Its input, output, and processing units or modules are labeled with numbers.

Given an input log file to this system (labeled as 1), Landmark analysis (labeled as 2) analyzes the log and computes abstract landmark delimiters (ALD) shown as module 3, which are the log patterns that are used as delimiters in the log tokenization.

Module 4 (Incremental Tokenization) gets two inputs, the original log and abstract landmark delimiters computed from the landmark analysis. It tokenizes the input log and generates an increasingly tokenized format by separating the patterns using ALD. The tokenized output log is shown as an intermediate tokenized log (module 5).

The landmark log processing is iterative, which means repeating the above process until no further processing is necessary. The above process was the first iteration. After that, the intermediate tokenization is fed into the module 2 for further identification of ALD and conversion.

The process going through the module 2, 3, 4, 5 is repeated as long as new ALDs are found. When there is no more new ALD available, the last intermediate tokenized log is labeled as the final tokenized log which is shown as the module 6 and the log processing finishes.

These tokenized logs are used for applications shown as module 7. These applications that we build include anomaly detection, fault diagnosis, and performance diagnosis. Due to the scope of work, their design is not presented in this invention. This invention will benefit them by increasing the quality of data. This invention is also applicable to other types of applications.

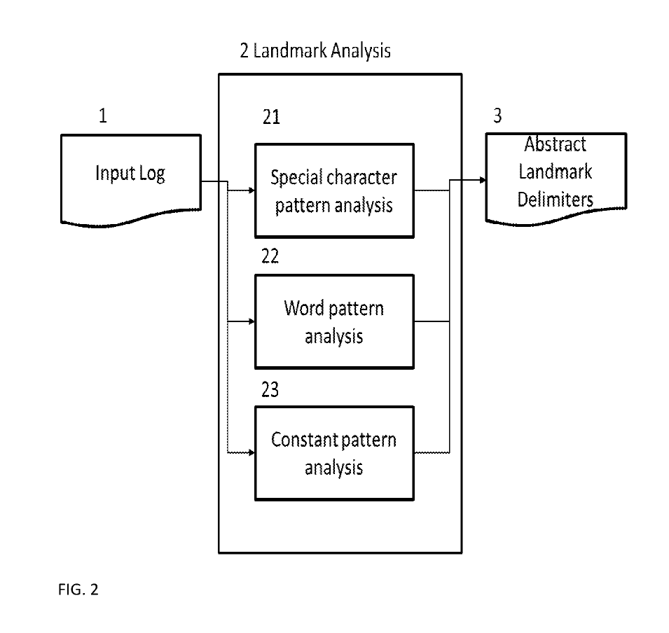

FIG. 2 presents Landmark analysis which is a procedure regarding how this invention determines abstract landmark delimiters (ALDs). The term Landmark refers to the characteristics of ALDs appearing consistently in the log. This landmark analysis (module 2) consists of three sub modules 21, 22, and 23, which will be explained next one by one. These three sub modules produce ALDs.

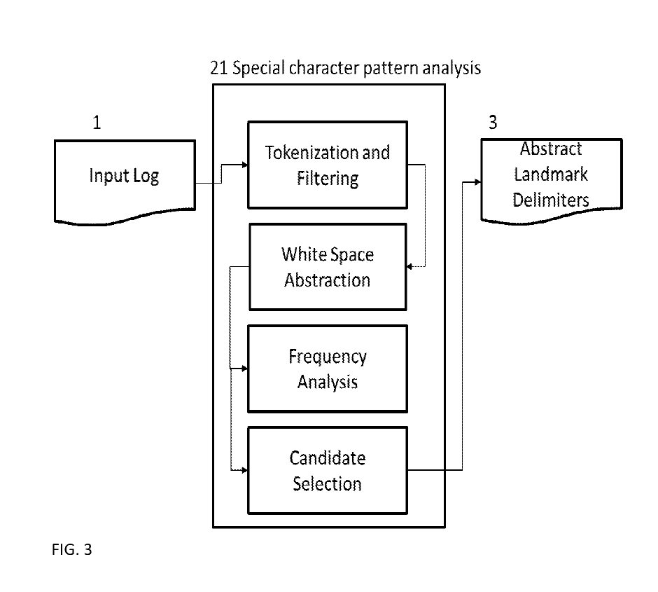

FIG. 3 presents the functional diagram of special character pattern analysis. Here are brief explanations of each function in 4 steps. Special characters are defined as non-numeric and non-alphabet characters such as #, $, @, !, “,”, etc.

Step 1: Tokenization and Filtering: This function filters out an alphabet or a numeric character so that only special characters are used for analysis.

Step 2: White Space Abstraction: Concatenated space characters are handled differently depending on their length. Thus space characters are converted to a special meta character “space_X” representing space with a length of X.

Step 3: Frequency Analysis: The method computes the frequency of special characters in each line and calculates its distribution and also computes the number of lines where they appear in the log.

Step 4: Candidate Selection: Based on the data computed in the Frequency Analysis, the candidates to be ALDs are selected. The policies on specific conditions for selection are variable depending on the data quality. One strict policy that we use is as follows. That is if a special character appears in every line and it appears the same number of times in every line, it is selected as a candidate.

Specific methods are presented below as pseudo-code.
Function Main represents the overall process.
Function TokenAndFilter is Step 1.
Function WhiteSpaceAbstraction is Step 2.
Function FrequencyAnalysis is Step 3.
Function CandidateSelection is Step 4.

Function Main(file)

TotalLine=get the number of lines of file

File=TokenAndFilter(file)

(D, A)=FrequencyAnalysis(File)

Candidates=CandidateSelection(D, A, TotalLine)

Function TokenAndFilter(file):

space_length=0

New File
For each line in a file:
New Line
   For each letter in a line: If WhiteSpaceAbstraction(Line, space_length, letter)>0

Continue
Line.Add (letter)
File.Add(Line)

Return File

Function WhiteSpaceAbstraction(Line, Space_length, letter)

If letter is a space:
Space_length+=1
Return 1

Else:
If Space_length>0:
   Line.Add (“space_”+makestring(space_length))
   Space_length=0
Return 0

Function Line::Add(letter)
If letter is an alphabet or a number:
   Return
Line::Frequency(letter)+=1

Function FrequencyAnalysis(File):

Initialize Distribution_Map

Initialize Appearance_Map

For each Line in a File:
For each (Letter, Frequency) in Map:
   Distribution_Map[Letter, Frequency]+=1
   Appearance_Map[Letter]+=1

Return (Distribution_Map, Apprearance_Map)

Function CandidateSelection(Distribution_Map, Appearance_Map, TotalLine):

Candidates=[ ]

For each (Letter,Value) in Apprearance_Map:
If Value==TotalLine:
   Candidates.append(Letter)

For each (Letter, Frequency_set) in Distribution_Map:
If size of Frequency_set !=1:
   Remove Letter from Candidates

Return Candidates

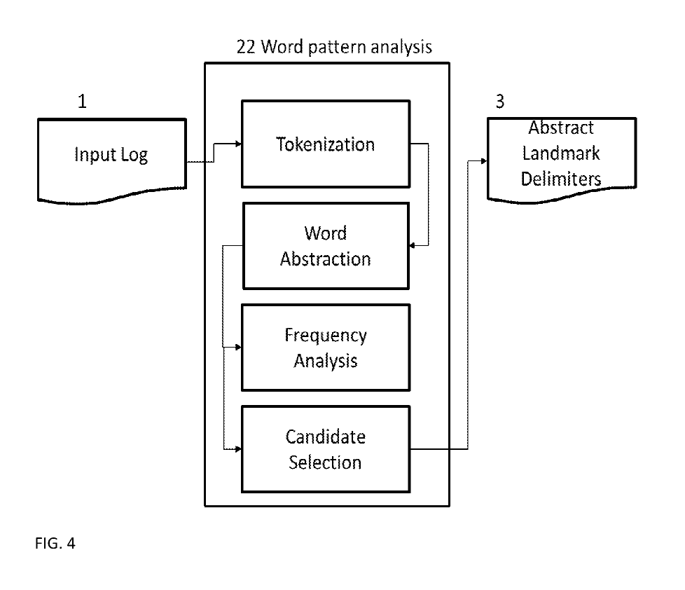

FIG. 4 presents the functional diagram of word pattern analysis. Here are brief explanations of each function as 4 steps.

Step 1: Tokenization: Log statements are tokenized with spaces in this analysis.

Step 2: Word Abstraction: To recognize similar patterns of words, this function converts each token to an abstract form. Here are specific conversion rules.
1) Alphabet “A” replaces one or more adjacent alphabets.
2) Digit “D” replaces one or more adjacent numbers.
3) Special characters other than alphabets and digits are directly used, but more than one adjacent characters are converted to a single character.

For example, “Albert0234-Number$32” becomes “AD-A$D” regarding to these rules.

Step 3: Frequency Analysis: The method computes the frequency of tokens in abstract forms. For each converted token, the method tracks how many lines include it.

Step 4: Candidate Selection: Based on the data computed in the Frequency Analysis, the candidates to be ALDs are selected. The policies on specific conditions for selection are variable depending on the data quality. One strict policy that we use is as follows. That is if a word pattern appears in every line, it is selected as a candidate.

Specific methods are presented below as pseudo-code.
Function Main represents the overall process.
Function Tokenize is Step 1.
Function WordAbstraction is Step 2.
Function FrequencyAnalysis is Step 3.
Function CandidateSelection is Step 4.

Function Main(file)

TotalLine=get the number of lines of file

File=Tokenize(file)

A=FrequencyAnalysis(File)

Candidates=CandidateSelection(A, TotalLine)

Function Tokenize(file):

New File

For each line in a file:
New Line
Tokens=a line is tokenized using white spaces as delimiters
For each Token in Tokens:
   AToken=WordAbstraction(Token)
   Line.Frequency[AToken]+=1
File.Add(Line)

Return File

Function WordAbstraction(Token)

AToken=empty string

Prev=empty string

For each character C in a Token:
If C is an alphabet:
   V=‘A’
   If Prev !=V:
      AToken=Concatenation of AToken and V
Else if C is a digit:
   V=‘D’
   If Prev !=V:
      AToken=Concatenation of AToken and V
Else:
   V=C
   If Prev !=V:
      AToken=Concatenation of AToken and V
Prev=V

Return AToken

Function FrequencyAnalysis(File):

Initialize Appearance_Map

For each Line in a File:
For each AToken of Line:
   Appearance_Map[AToken]+=1

Return Apprearance_Map

Function CandidateSelection(Appearance_Map, TotalLine):

Candidates=[ ]

For each (AToken,Value) in Apprearance_Map:
If Value==TotalLine:
   Candidates.append(AToken)
Return Candidates

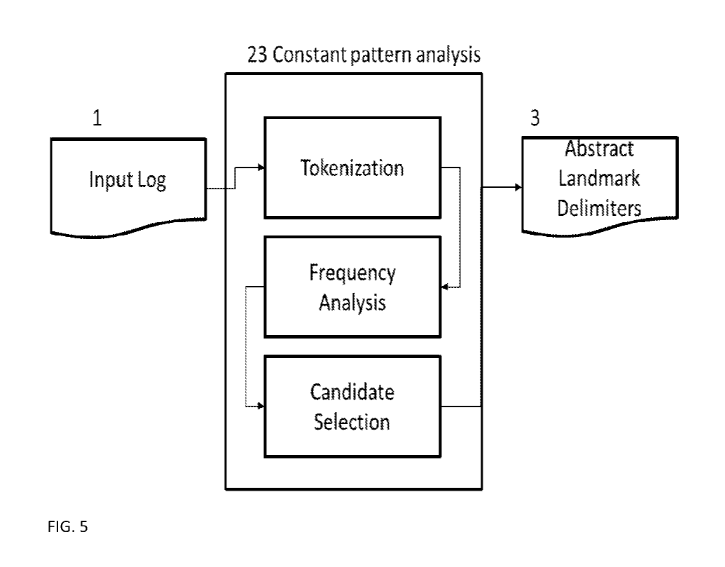

FIG. 5 presents the functional diagram of constant pattern analysis. Here are brief explanations of each function as 3 steps.

Step 1: Tokenization: Log statements are tokenized with spaces in this analysis.

Step 2: Frequency Analysis: The method computes the frequency of tokens. For each token, the method tracks how many lines include it.

Step 3: Candidate Selection: Based on the data computed in the Frequency Analysis, the candidates to be ALDs are selected. The policies on specific conditions for selection are variable depending on the data quality. One strict policy that we use is as follows. That is if a constant pattern appears in every line, it is selected as a candidate.

Specific methods are presented below as pseudo-code.
Function Main represents the overall process.
Function Tokenize is Step 1.
Function FrequencyAnalysis is Step 2.
Function CandidateSelection is Step 3.

Function Main(file)

TotalLine=get the number of lines of file

File=Tokenize(file)

A=FrequencyAnalysis(File)

Candidates=CandidateSelection(A, TotalLine)

Function Tokenize(file):

New File

For each line in a file:
New Line
Tokens=a line is tokenized using white spaces as delimiters
For each Token in Tokens:
   Line.Frequency[Token]+=1
File.Add(Line)

Return File

Function FrequencyAnalysis(File):

Initialize Appearance_Map

For each Line in a File:
For each Token in Line:
   Appearance_Map[Token]+=1

Return Apprearance_Map

Function CandidateSelection(Appearance_Map, TotalLine):

Candidates=[ ]

For each (Token,Value) in Apprearance_Map:
If Value==TotalLine:
   Candidates.append(Token)
Return Candidates

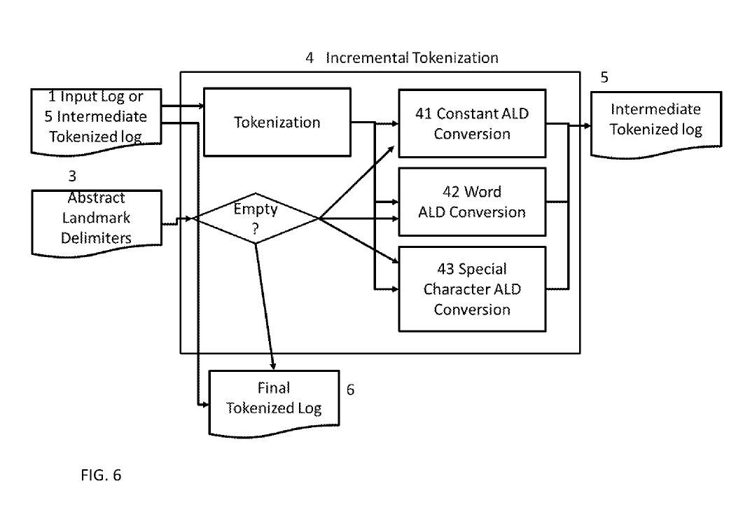

FIG. 6 presents the functional diagram of Incremental Tokenization process. This module gets two inputs: One is a log (which is either the input log or an intermediate tokenized log) and the other is the abstract landmark delimiters (ALD) produced in the landmark analysis. If the ALD is empty, the Incremental Tokenization process finishes and returns the log as the final tokenized log. Essentially, in the iterative process shown in FIG. 1, the last converted log becomes the final converted log.

When the ALD is not empty, each log is tokenized and converted into another log by using ALDs. ALDs are produced from 3 different analyses causing three sets of results: special character ALD, word ALD, and constant ALD. These ALDs are correspondingly used in three conversions shown in module 43, 42, and 41 in FIG. 6.

There three sets of ALDs may have overlaps in the coverage of tokens in the conversion. For instance, a constant ALD “A@B” and a special character ALD “@” have a special character “@” in common. To avoid any confusion the conversion process apply ALDs in different priority.

In general, three ALDs have difference in the degree how specific each pattern could be. Typically a constant ALD represent a commonly used original token while the word ALD is an abstract form and a special character ALD can be used in any tokens. Due to this difference, we give higher priority on conversion using constant ALDs followed by word ALDs and special character ALDs.

Specifically for each token from the input log, if it first matches any constant ALD, it is converted in the module 41 (Constant ALD Conversion). If there is no matching case, then it will check whether it matches any word ALD, and it is converted in the module 42 (Word ALD Conversion). If neither of ALDs match the given token, then the special character ALDs are checked. If there is any match, the token is converted in the module 43 (Special character ALD Conversion). If no match is found, the method uses the original token and continues the processing of the next token.

Specific methods are presented below as pseudo-code.
The function ConstantALDConversion represents the module 41. If the token matches one of Constant ALDs, a converted token processed by ConversionFull is returned.
The function WordALDConversion represents the module 42. The input token is first converted to an abstract token AToken. If it matches any Word ALDs, a converted token processed by ConversionFull is returned.
The function SpecialCharALDConversion represents the module 43. Each character in the token is checked whether it belongs to Special character ALDs. If so, a converted token is returned.

Function ConstantALDConversion(Token, ConstantALDs)

If Token in ConstantALDs:
Return ConversionFull(Token)

Return Token

Function WordALDConversion(Token, WordALDs)

AToken=WordAbstraction(Token)

If AToken in WordALDs:
Return ConversionFull(Token)

Return Token

Function SpecialCharALDConversion(Token, SpecialCharALDs)

Return ConversionSpecialChar(token, SpecialCharALDs)

Function getKind(C)

If C is an alphabet, return ‘A’

If C is a digit, return ‘D’

Return ‘S’

Function ConversionFull(token)

CToken=[ ]

PToken=empty string

PrevKind=empty

For each C in token:
Kind=getKind(C)
If C is the first character or Kind==PrevKind:
   PToken+=C
Else:
   CToken.Insert(PToken)
   PToken=C
PrevKind=kind

If PToken !=empty string:
CToken.Insert(PToken)

Return CToken

Function ConversionSpecialChar(token, SpecialCharALD)

CToken=[ ]

PToken=empty string

PrevHit=False

ThisHit=False

For each C in token:
If C in SpecialCharALD:
   ThisHit=True
Else
   ThisHit=False
If C is the first character:
   PToken+=C
Else if PrevHit==False:
   If ThisHit==True:
      CToken.Insert(PToken)
      PToken=C
Else:
   PToken+=C

Else:
CToken.Insert(PToken)
   PToken=C
PrevHit=ThisHit

If PToken !=empty string:
CToken.Insert(PToken)

Return CToken

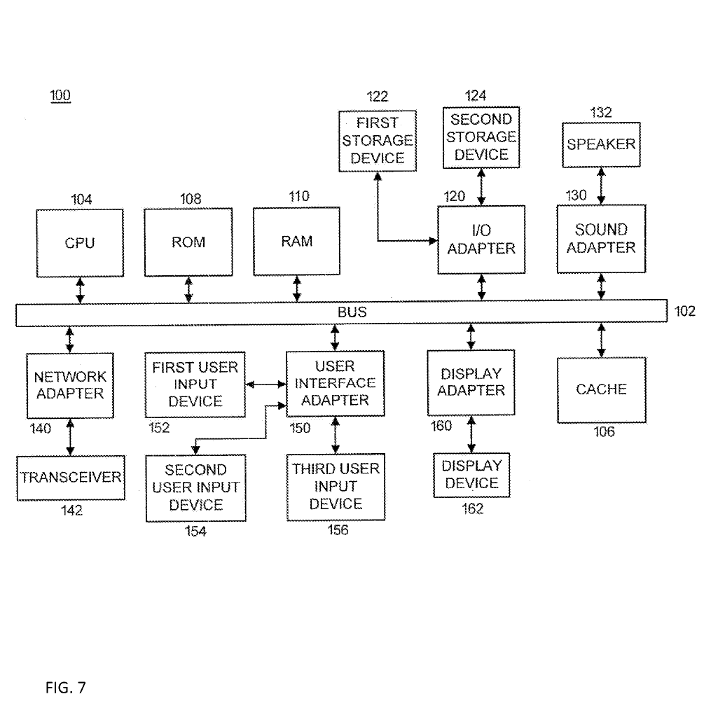

Referring to the drawings in which like numerals represent the same or similar elements and initially to FIG. 7, a block diagram describing an exemplary processing system 100 to which the present principles may be applied is shown, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to a system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to the system bus 102 by the sound adapter 130. A transceiver 142 is operatively coupled to the system bus 102 by a network adapter 140. A display device 162 is operatively coupled to the system bus 102 by a display adapter 160. A first user input device 152, a second user input device 154, and a third user input device 156 are operatively coupled to the system bus 102 by a user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used while maintaining the spirit of the present principles. The user input devices 152, 154, and 156 can be the same type of user input device or different types of user input devices. The user input devices 152, 154, and 156 are used to input and output information to and from the system 100.

Of course, the processing system 100 may also include other elements (not shown), as readily contemplated by one of skill in the art, as well as omit certain elements. For example, various other input devices and/or output devices can be included in the processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations, can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for analyzing logs generated by a machine, comprising:
analyzing a log and identifying one or more abstract landmark delimiters (ALDs) representing delimiters for log tokenization;
from the log and ALDs, tokenizing the log and generating an increasingly tokenized format by separating the patterns with the ALD to form an intermediate tokenized log;
iteratively repeating the tokenizing of the logs until a last intermediate tokenized log is processed as a final tokenized log; and
applying the tokenized logs in applications.

2. The method of claim 1, comprising converting each token into an abstract representation.

3. The method of claim 2, wherein a character “A” replaces one or more adjacent alphabets and digit “D” replaces one or more adjacent numbers.

4. The method of claim 2, wherein special characters other than alphabets and digits are used, and adjacent characters are converted to a single character.

5. The method of claim 1, comprising determining a frequency of tokens in abstract forms, where for each converted token, tracking how many lines include the token.

6. The method of claim 5, comprising selecting candidates for the ALDs.

7. The method of claim 5, comprising applying policies on specific conditions for ALD selection variably depending on data quality.

8. The method of claim 5, wherein if a word pattern appears in every line, the word pattern is selected as a candidate.

9. The method of claim 1, comprising determining a constant pattern and when the ALD is not empty, each log is tokenized and converted into another log by using the ALDs.

10. The method of claim 1, comprising producing ALDs with three different analyses and generating three sets of results: special character ALD, word ALD, and constant ALD.

11. A system for handling a log, comprising:
a processor; and
a module for processing the log with code for:
analyzing the log and identifying one or more abstract landmark delimiters (ALDs) representing delimiters for log tokenization;
from the log and ALDs, tokenizing the log and generating an increasingly tokenized format by separating the patterns with the ALD to form an intermediate tokenized log;
iteratively repeating the tokenizing of the logs until a last intermediate tokenized log is processed as a final tokenized log; and
applying the tokenized logs in applications.

12. The system of claim 11, comprising code for converting each token into an abstract representation.

13. The system of claim 12, wherein a character “A” replaces one or more adjacent alphabets and digit “D” replaces one or more adjacent numbers.

14. The system of claim 12, wherein special characters other than alphabets and digits are used, and adjacent characters are converted to a single character.

15. The system of claim 11, comprising code for determining a frequency of tokens in abstract forms, where for each converted token, tracking how many lines include the token.

16. The system of claim 15, comprising code for selecting candidates to be abstract landmark delimiters (ALDs).

17. The system of claim 15, comprising code for applying policies on specific conditions for ALD selection variably depending on data quality.

18. The system of claim 5, wherein if a word pattern appears in every line, the word pattern is selected as a candidate.

19. The system of claim 11, comprising code for determining a constant pattern and when the ALD is not empty, each log is tokenized and converted into another log by using the ALDs.

20. The system of claim 11, comprising code for producing ALDs with three different analyses and generating three sets of results: special character ALD, word ALD, and constant ALD.

21. The system of claim 11, comprising:
a mechanical actuator; and
a digitizer coupled to the actuator to log data.
